(19) United States
(12) Patent Application Publication
(10) Pub. No.: US 2024/0196351 A1
(43) Pub. Date: Jun. 13, 2024

(54) USER EQUIPMENT, BASE STATION, AND WIRELESS COMMUNICATION METHOD

(71) Applicant: GUANGDONG OPPO MOBILE TELECOMMUNICATIONS CORP., LTD., Dongguan (CN)

(72) Inventor: Hao LIN, Neuilly-sur-Seine (FR)

(73) Assignee: GUANGDONG OPPO MOBILE TELECOMMUNICATIONS CORP., LTD., Dongguan (CN)

(21) Appl. No.: 18/581,999

(22) Filed: Feb. 20, 2024

Related U.S. Application Data
(63) Continuation of application No. PCT/IB2021/000774, filed on Sep. 30, 2021.

(51) Int. Cl. H04W 56/00; H04B 7/185; H04W 72/232

(52) U.S. Cl. CPC H04W 56/0045; H04B 7/18513; H04W 72/232

(57) ABSTRACT

A wireless communication method and a user equipment (UE) are provided. The wireless communication method by the UE includes operations as follows. The base station or a serving cell of the UE configures with a validity duration, a first information including a satellite ephemeris data and/or a timing advance related parameter is received from the serving cell within the validity duration, and a starting time for the validity time is derived.

### CROSS-REFERENCE TO RELATED APPLICATIONS

This is a continuation application of International Patent Application No. PCT/IB2021/000774, filed on Sep. 30, 2021, the disclosure of which is hereby incorporated by reference in its entirety.

### BACKGROUND OF DISCLOSURE

### 1. Field of the Disclosure

The present disclosure relates to the field of communication systems, and more particularly, to a user equipment, a base station, and a wireless communication method, which can provide a good communication performance and/or high reliability.

### 2. Description of the Related Art

Non-terrestrial networks (NTNs) refer to networks, or segments of networks, using a spaceborne vehicle or an airborne vehicle for transmission. Spaceborne vehicles include satellites including low earth orbiting (LEO) satellites, medium earth orbiting (MEO) satellites, geostationary earth orbiting (GEO) satellites, and highly elliptical orbiting (HEO) satellites. Airborne vehicles include high altitude platforms (HAPs) encompassing unmanned aircraft systems (UAS) including lighter than air (LTA) unmanned aerial systems (UAS) and heavier than air (HTA) UAS, all operating in altitudes typically between 8 and 50 km, quasi-stationary.

Communication via a satellite is an interesting means thanks to its well-known coverage, which can bring the coverage to locations that normally cellular operators are not willing to deploy either due to non-stable crowd potential client, e.g., extreme rural, or due to high deployment cost, e.g. middle of ocean or mountain peak. Nowadays, the satellite communication is a separate technology to a 3rd generation partnership project (3GPP) cellular technology. Coming to 5G era, these two technologies can merge together, i.e., we can imagine having a 5G terminal that can access to a cellular network and a satellite network. The NTN can be good candidate technology for this purpose. It is to be designed based on 3GPP new radio (NR) with necessary enhancement.

In a terrestrial network, e.g., Release 15, a timing advance for an uplink transmission is controlled by a network via a timing advance command (TAC), i.e., TS 38.213. A UE does not update a TA until it receives a new TAC. In an NTN system, when a satellite is moving with a high velocity with regard to a UE position on earth, relying solely on the network to control a synchronization adjustment does not seem to be feasible, since the synchronization adjustment needs to be performed very often, leading to an unaffordable signaling overhead.

Communication over unlicensed spectrum: In an unlicensed band, an unlicensed spectrum is a shared spectrum. Communication equipments in different communication systems can use the unlicensed spectrum as long as the unlicensed meets regulatory requirements set by countries or regions on a spectrum. There is no need to apply for a proprietary spectrum authorization from a government.

In order to allow various communication systems that use the unlicensed spectrum for wireless communication to coexist friendly in the spectrum, some countries or regions specify regulatory requirements that must be met to use the unlicensed spectrum. For example, a communication device follows a listen before talk (LBT) procedure, that is, the communication device needs to perform a channel sensing before transmitting a signal on a channel. When an LBT outcome illustrates that the channel is idle, the communication device can perform signal transmission; otherwise, the communication device cannot perform signal transmission. In order to ensure fairness, once a communication device successfully occupies the channel, a transmission duration cannot exceed a maximum channel occupancy time (MCOT).

On an unlicensed carrier, for a channel occupation time obtained by a base station, it may share the channel occupation time to a user equipment (UE) for transmitting an uplink signal or an uplink channel. In other words, when the base station shares its own channel occupancy time with the UE, the UE can use an LBT mode with higher priority than that used by the UE itself to obtain the channel, thereby obtaining the channel with greater probability. LBT is also called channel access procedure. UE performs channel access procedure before the transmission, if the channel access procedure is successful, i.e., the channel is sensed to be idle, the UE starts to perform the transmission. If the channel access procedure is not successful, i.e., the channel is sensed to be not idle, the UE cannot perform the transmission.

In the latest new radio unlicensed (NRU) system, if the NRU system is configured to be semi-static channel access mode, the UE cannot initiate a channel occupancy time (MCOT), and the UE has to detect a downlink signal before being allowed to transmit any uplink transmission. This will greatly limit a UE performance, and notably increasing transmission latency. To envision any latency stringent service, e.g., factory machine type communications or high quality surveillance, the latency needs to be reduced.

In NTN, due to very high satellite altitude, a round trip time (RTT) between a sender (satellite/user equipment (UE)) and a receiver (UE/satellite) is extremely long. The communications shall need to take this long RTT into account for data transmission. An offset, which is used to absorb the long RTT, is used for determining an uplink transmission. But in RACH procedure, idle UE and connected UE might access to a same RACH occasion (RO), moreover a base station may not have prior knowledge about which one who attempts to transmit PRACH in a given RO, therefore the base station might not be able to adapt a suitable offset value for the subsequent PUSCH transmission.

Therefore, there is a need for a user equipment, a base station, and a wireless communication method, which can solve issues in the prior art, establish a synchronization in uplink, provide a method for the UE to track a satellite status information, provide a good communication performance, and/or provide high reliability.

### SUMMARY

An object of the present disclosure is to propose a user equipment and a wireless communication method, which can solve issues in the prior art, establish a synchronization in uplink, provide a method for the UE to track a satellite status information, provide a good communication performance, and/or provide high reliability.

In a first aspect of the present disclosure, a wireless communication method by a user equipment (UE) includes being configured, by a base station or a serving cell of the UE, with a validity duration, receiving a first information comprising a satellite ephemeris data and/or a timing advance related parameter from the serving cell within the validity duration, and deriving a starting time for the validity time.

In a second aspect of the present disclosure, a wireless communication method comprises configuring or controlling a serving cell of a user equipment (UE) to configure, to the UE, a validity duration, controlling the UE to receive a first information comprising a satellite ephemeris data and/or a timing advance related parameter from the serving cell within the validity duration, and controlling the UE to derive a starting time for the validity time.

In a third aspect of the present disclosure, a user equipment comprises a memory, a transceiver, and a processor coupled to the memory and the transceiver. The processor is configured, by a base station or a serving cell of the UE, with a validity duration, the transceiver is configured to receive a first information comprising a satellite ephemeris data and/or a timing advance related parameter from the serving cell within the validity duration, and the processor is configured to derive a starting time for the validity time

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating random access procedures according to an embodiment of the present disclosure.

FIG. 2 is a block diagram of one or more user equipments (UEs) and a base station (e.g., gNB) of communication in a communication network system (e.g., non-terrestrial network (NTN) or a terrestrial network) according to an embodiment of the present disclosure.

FIG. 3 is a flowchart illustrating a wireless communication method performed by a user equipment (UE) according to an embodiment of the present disclosure.

FIG. 4 is a flowchart illustrating a wireless communication method performed by a base station according to an embodiment of the present disclosure.

FIG. 5 is a schematic diagram illustrating a communication system including a base station (BS) and a UE according to an embodiment of the present disclosure.

FIG. 6 is a schematic diagram illustrating that a BS transmits 3 beams to the ground forming 3 footprints according to an embodiment of the present disclosure.

FIG. 7 is a schematic diagram illustrating a validity duration in a channel according to an embodiment of the present disclosure.

FIG. 8 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In NTN, due to very high satellite altitude, a round trip time (RTT) between a sender (satellite/user equipment (UE)) and a receiver (UE/satellite) is extremely long. The communications shall need to take this long RTT into account for data transmission. An offset, which is used to absorb the long RTT, is used for determining an uplink transmission. But in a physical random access channel (PRACH) procedure, idle UE and connected UE might access to a same RACH occasion (RO), moreover a base station may not have prior knowledge about which one who attempts to transmit PRACH in a given RO, therefore the base station might not be able to adapt a suitable offset value for the subsequent PUSCH transmission. In some embodiments of the present disclosure, several methods and/or technical solutions are provided to address this ambiguity and/or issue.

As used herein, a connected UE refers to a UE in a connected state, while an idle UE refers to a UE in an idle state. That is, a connected UE means a set of serving UEs in a cell of a base station, and an idle UE means a UE this has registered with a network but has no non access stratum (NAS) (i.e., core network) connection(s).

A random access procedure is triggered by a number of events: Initial access from RRC_IDLE; RRC Connection Re-establishment procedure; DL or UL data arrival during RRC_CONNECTED when UL synchronisation status is “non-synchronised”; UL data arrival during RRC_CONNECTED when there are no PUCCH resources for SR available; SR failure; Request by RRC upon synchronous reconfiguration (e.g. handover); Transition from RRC_INACTIVE; To establish time alignment for a secondary TAG; Request for Other SI; Beam failure recovery; or Consistent UL LBT failure on SpCell.

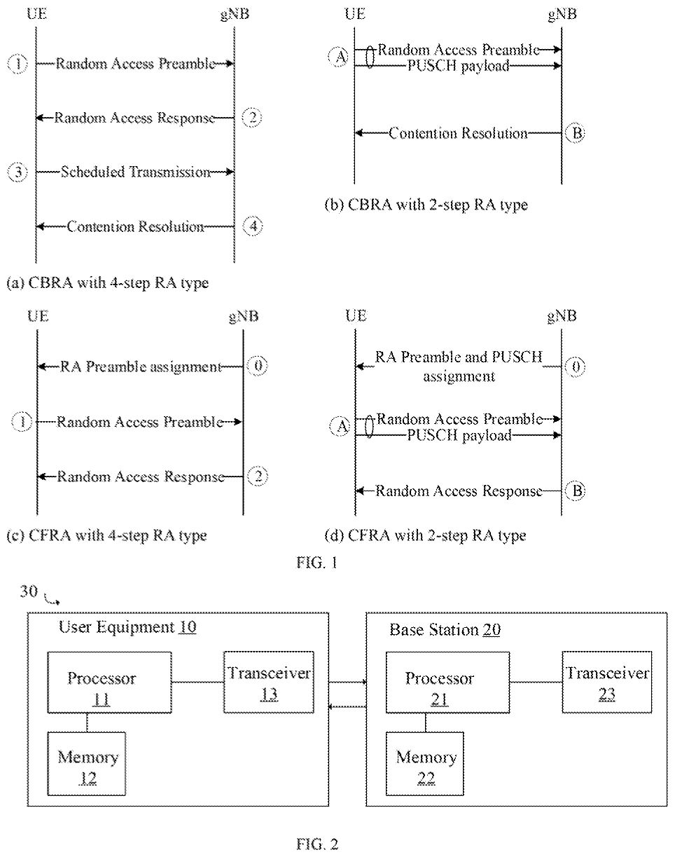

Two types of random access procedure are supported: 4-step RA type with MSG1 and 2-step RA type with MSGA. Both types of RA procedure support contention-based random access (CBRA) and contention-free random access (CFRA) as illustrated on FIG. 1 below. The UE selects the type of random access at initiation of the random access procedure based on network configuration: When CFRA resources are not configured, an RSRP threshold is used by the UE to select between 2-step RA type and 4-step RA type; when CFRA resources for 4-step RA type are configured, UE performs random access with 4-step RA type; and/or or when CFRA resources for 2-step RA type are configured, UE performs random access with 2-step RA type. The network does not configure CFRA resources for 4-step and 2-step RA types at the same time for a Bandwidth Part (BWP). CFRA with 2-step RA type is only supported for handover.

The MSG1 of the 4-step RA type consists of a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure as illustrated in FIG. 1(c). For CBRA, upon reception of the random access response, the UE sends MSG3 using the UL grant scheduled in the response and monitors contention resolution as illustrated in FIG. 1(a). If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure as illustrated in FIG. 1(d). For CBRA, if contention resolution is successful upon receiving the network response, the UE ends the random access procedure illustrated in FIG. 1(b); while if fallback indication is received in MSGB, the UE performs MSG3 transmission using the UL grant scheduled in the fallback indication and monitors contention resolution as illustrated in FIG. 1. If contention resolution is not successful after MSG3 (re)transmission(s), the UE goes back to MSGA transmission. If the random access procedure with 2-step RA type is not completed after a number of MSGA transmissions, the UE can be configured to switch to CBRA with 4-step RA type.

For random access in a cell configured with SUL, the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

When CA is configured, random access procedure with 2-step RA type is only performed on PCell while contention resolution can be cross-scheduled by the PCell. When CA is configured, for random access procedure with 4-step RA type, the first three steps of CBRA always occur on the PCell while contention resolution (step 4) can be cross-scheduled by the PCell. The three steps of a CFRA started on the PCell remain on the PCell. CFRA on SCell can only be initiated by the gNB to establish timing advance for a secondary TAG: the procedure is initiated by the gNB with a PDCCH order (step 0) that is sent on a scheduling cell of an activated SCell of the secondary TAG, preamble transmission (step 1) takes place on the indicated SCell, and Random Access Response (step 2) takes place on PCell.

FIG. 2 illustrates that, in some embodiments, one or more user equipments (UEs) 10 and a base station (e.g., gNB) 20 for communication in a communication network system 30 (e.g., non-terrestrial network (NTN) or terrestrial network) according to an embodiment of the present disclosure are provided. The communication network system 30 includes the one or more UEs 10 and the base station 20. The one or more UEs 10 may include a memory 12, a transceiver 13, and a processor 11 coupled to the memory 12, the transceiver 13. The base station 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the communication between the UE 10 and the BS 20 comprises non-terrestrial network (NTN) communication. In some embodiments, the base station 20 comprises spaceborne platform or airborne platform or high altitude platform station.

In some embodiments, the processor 11 is configured, by the base station 20 or a serving cell of the UE 10, with a validity duration, the transceiver is configured to receive a first information comprising a satellite ephemeris data and/or a timing advance related parameter from the serving cell within the validity duration, and the processor 11 is configured to derive a starting time for the validity time. This can solve issues in the prior art, establish a synchronization in uplink, provide a method for the UE to track a satellite status information, provide a good communication performance, and/or provide high reliability.

In some embodiments, the processor 21 is configured to: configure or control a serving cell of a user equipment (UE) to configure, to the UE, a validity duration, control the UE to receive a first information comprising a satellite ephemeris data and/or a timing advance related parameter from the serving cell within the validity duration, and control the UE to derive a starting time for the validity time. This can solve issues in the prior art, establish a synchronization in uplink, provide a method for the UE to track a satellite status information, provide a good communication performance, and/or provide high reliability.

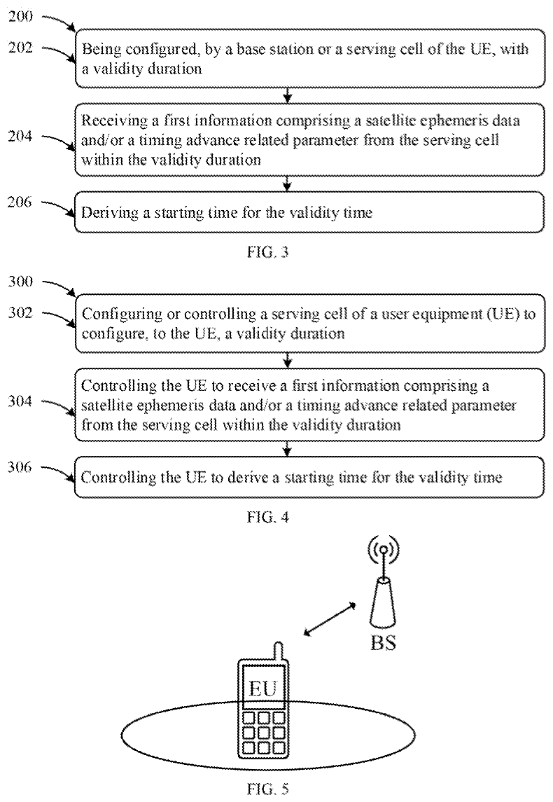

FIG. 3 illustrates a wireless communication method 200 performed by a UE according to an embodiment of the present disclosure. In some embodiments, the method 200 includes: a block 202, being configured, by a base station or a serving cell of the UE, with a validity duration, a block 204, receiving a first information comprising a satellite ephemeris data and/or a timing advance related parameter from the serving cell within the validity duration, and a block 206, deriving a starting time for the validity time. This can solve issues in the prior art, establish a synchronization in uplink, provide a method for the UE to track a satellite status information, provide a good communication performance, and/or provide high reliability.

FIG. 4 illustrates a wireless communication method 300 performed by a base station according to an embodiment of the present disclosure. In some embodiments, the method 300 includes: a block 302, configuring or controlling a serving cell of a user equipment (UE) to configure, to the UE, a validity duration, a block 304, controlling the UE to receive a first information comprising a satellite ephemeris data and/or a timing advance related parameter from the serving cell within the validity duration, and a block 306, controlling the UE to derive a starting time for the validity time. This can solve issues in the prior art, establish a synchronization in uplink, provide a method for the UE to track a satellite status information, provide a good communication performance, and/or provide high reliability.

In some embodiments, the first information is received from a system information, a UE-dedicated radio resource control (RRC) signaling, or a media access control-control element (MAC-CE). In some embodiments, the system information comprises a system information block (SIB). In some embodiments, the first information is applied for the serving cell. In some embodiments, the validity duration is a time interval with a unit of an absolute time and/or a slot, where a length of the slot is derived according to a subcarrier spacing or a frame. In some embodiments, the first information is carried in a first physical downlink shared channel (PDSCH). In some embodiments, the first PDSCH comprises the system information and the first PDSCH is broadcasted to UEs within the serving cell. In some embodiments, the first PDSCH comprises the UE-dedicated RRC signaling and the first PDSCH is transmitted to the UE.

In some embodiments, the starting time of the validity duration is relevant to a reception of the first PDSCH. In some embodiments, the starting time is relevant to a slot or a frame in which the first PDSCH is received. In some embodiments, the starting time is a boundary of the slot or a boundary of the frame in which the first PDSCH is received. In some embodiments, the starting time is relevant to a reception of a second PDSCH. In some embodiments, the starting time is relevant to a slot or a frame in which the second PDSCH is received. In some embodiments, the starting time is a boundary of the slot or a boundary of the frame in which the second PDSCH is received. In some embodiments, the second PDSCH is periodically transmitted by the serving cell. In some embodiments, the starting time is relevant to an earliest one PDSCH as the second PDSCH after the reception of the first PDSCH.

In some embodiments, the second PDSCH satisfies a processing time, where an interval from a last symbol of the first PDSCH to a first symbol of the second PDSCH is greater than or equal to a second time interval. In some embodiments, the second time interval is relevant to a processing PDSCH time of the UE. In some embodiments, the second time interval is pre-defined. In some embodiments, the first PDSCH and the second PDSCH are same. In some embodiments, when the second PDSCH is periodically transmitted by the serving cell and when the UE starts the validity duration from the starting time, the UE receives at least once the second PDSCH again within the validity time. In some embodiments, after the UE receives again the second PDSCH, the UE starts a new validity duration from a new starting time. In some embodiments, the UE is configured to report, to the base station, the new validity duration. In some embodiments, the UE is configured to report, to the base station, the new validity duration by sending an uplink channel.

In some embodiments, the uplink channel comprises at least one of the followings: a physical random access channel (PRACH), a physical uplink control channel (PUCCH), a physical uplink shared channel (PUSCH), or a sounding reference signal (SRS). In some embodiments, the UE follows a pre-defined rule to receive the second PDSCH again within the validity duration. In some embodiments, the pre-defined rule is that when the UE starts the validity duration and there are multiple periodic second PDSCHs transmitted by the base station during the validity duration, the UE receives a last second PDSCH that is closest to an end of the validity duration. In some embodiments, the method further comprises being configured, by the base station, with a monitoring window and monitoring a physical downlink control channel (PDCCH) that schedules the first PDSCH and/or the second PDSCH. In some embodiments, the UE monitors the PDCCH according to a search space set within the monitoring window, where the search space set is pre-configured or pre-defined by the base station. In some embodiments, the search space set comprises a common search space set.

In some embodiments, a start of the monitoring window is periodic and/or is pre-configured. In some embodiments, a start of the monitoring window is triggered by the base station, where the UE receives a second information from the base station before starting the monitoring window. In some embodiments, when the UE is configured with an active downlink (DL) bandwidth part (BWP), the active DL BWP in frequency domain does not cover an initial DL BWP or a subcarrier spacing (SCS) of the active DL BWP is different from an SCS of the initial DL BWP, the first information is received from the UE-dedicated RRC signaling or the MAC-CE. In some embodiments, after the UE receives the first information, the UE restarts the validity duration. In some embodiments, the validity duration comprises a validity timer. In some embodiments, when the validity timer is not running or expired, or when the UE does not receive another second PDSCH within the validity duration, the UE assumes an uplink synchronization lost.

In some embodiments, when the UE assumes the uplink synchronization lost, the UE performs a RACH procedure. In some embodiments, when an active uplink (UL) BWP of the UE is configured with RACH occasions, the UE performs the RACH procedure in the active UL BWP. In some embodiments, when the UE first switches from an active UL BWP to an initial UL BWP, the UE performs the RACH procedure in the initial UL BWP. In some embodiments, before the UE performs the RACH procedure, the UE receives the first information. In some embodiments, the RACH procedure comprises the UE transmitting a message on a RACH occasion configuring an initial UL BWP or an active UL BWP, wherein the initial UL BWP or the active UL BWP provides an updated dedicated resource. In some embodiments, the RACH procedure comprises the UE receiving a response from the base station, and the response provides an updated first information. In some embodiments, the RACH procedure comprises at least one of the followings: a type 1 random access procedure, or a type 2 random access procedure.

In some embodiments, the type 1 random access procedure comprises a 4-step resource allocation (RA) type or the type 2 random access procedure comprises a 2-step RA type. In some embodiments, the 4-step RA type comprises the UE transmitting a message 1 (Msg1) as the message on a physical random access channel (PRACH) transmission, wherein the Msg1 comprises a preamble. In some embodiments, the 4-step RA type comprises the UE receiving a random access response (RAR) as the response to the Msg1 from the base station. In some embodiments, the 2-step RA type comprises the UE transmitting a message A (MsgA) as the message on a PRACH transmission and a first physical uplink shared channel (PUSCH) transmission, wherein the Msg A comprises a preamble and a payload. In some embodiments, the 2-step RA type comprises the UE receiving a RAR as the response to the MsgA from the base station. In some embodiments, the RACH procedure comprises a contention-based random access procedure (CBRA) and/or a contention-free random access procedure (CFRA).

In some embodiments, when the validity timer is not running or expired or the UE does not receive another second PDSCH within the validity duration, the UE performs at least one of the followings: wherein the UE declares an UL synchronization lost; wherein the UE declares a radio link failure; wherein the UE performs a procedure as if a time alignment timer is not running; or wherein the UE switches to an idle state. In some embodiments, the UE is provided, by the base station, with a third information, where a content of the third information is same or similar to the first information except that the third information is applied for a non-serving cell. In some embodiments, the third information is provided in an RRC message. In some embodiments, the third information is provided in a measurement object information element (IE). In some embodiments, a second validity duration for the third information is provided by the base station, where the second validity duration is of the same value of the validity duration applied for the serving cell. In some embodiments, the UE performs measurement for a non-serving cell when the validity duration is not expired or when the validity timer is still running.

FIG. 5 illustrates a communication system including a base station (BS) and a UE according to another embodiment of the present disclosure. Optionally, the communication system may include more than one base stations, and each of the base stations may connect to one or more UEs. In this disclosure, there is no limit. As an example, the base station illustrated in FIG. 2 may be a moving base station, e.g. spaceborne vehicle (satellite) or airborne vehicle (drone). The UE can transmit transmissions to the base station and the UE can also receive the transmission from the base station. Optionally, not shown in FIG. 5, the moving base station can also serve as a relay which relays the received transmission from the UE to a ground base station or vice versa. Optionally, a satellite may be seen as a relay point which relays the communications between a UE and a base station, e.g., gNB/eNB.

Spaceborne platform includes satellite and the satellite includes LEO satellite, MEO satellite and GEO satellite. While the satellite is moving, the LEO and MEO satellite is moving with regards to a given location on earth. However, for GEO satellite, the GEO satellite is relatively static with regards to a given location on earth. A spaceborne or airborne base station (BS), e.g. in particular for LEO satellite or drone, communicates with a user equipment (UE) on the ground. In order to ensure a good communication between the satellite or base-station (or network in general) and a UE, a synchronization in uplink can be established. For performing the synchronization, the UE needs to know an ephemeris data of the satellite so that the UE can predict the trajectory of the satellite as well as the velocity at a given time. In some embodiments of this disclosure, some examples present a method for a UE to track a satellite status information including an ephemeris data. Some embodiments of this disclosure can be applied for an NTN NR system as well as an Internet of things (IOT) system. IoT system may also be referred to as NB-IOT system or narrow band-long term evolution (NB-LTE) system.

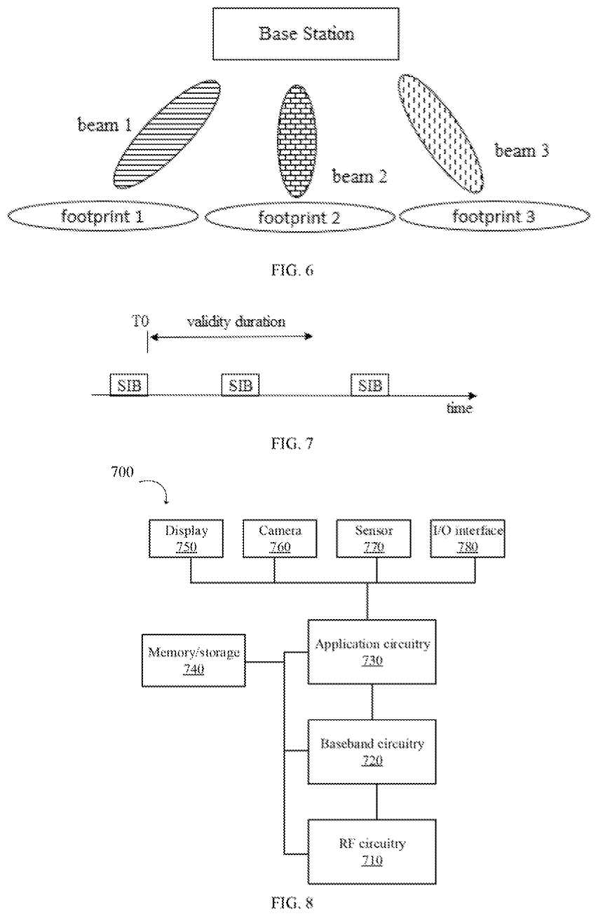

Optionally, as illustrated in FIG. 6, where a base station is integrated in a satellite or a drone, and the base station transmits one or more beams to the ground forming one or more coverage areas called footprint. In FIG. 6, an example illustrates that the BS transmits three beams (beam 1, beam 2 and beam3) to form three footprints (footprint 1, 2 and 3), respectively. Optionally, 3 beams are transmitted at 3 different frequencies. In this example, the bit position is associated with a beam. FIG. 6 illustrates that, in some embodiments, a moving base station, e.g. in particular for LEO satellite or drone, communicates with a user equipment (UE) on the ground. Due to long distance between the UE and the base station on satellite the beamformed transmission is needed to extend the coverage. As illustrated in FIG. 6, where a base station is transmitting three beams to the earth forming three coverage areas called footpoints. Moreover, each beam may be transmitted at dedicated frequencies so that the beams for footprint 1, 2 and 3 are non-overlapped in a frequency domain.

FIG. 7 illustrates a validity duration in a channel according to an embodiment of the present disclosure. In some embodiments, a UE is configured by a network or by its serving cell with a validity duration. The UE can receive at least once a first information from a serving cell within a validity duration. In some examples, the first information is received from system information (e.g., SIB), a UE-dedicated RRC signaling, or a MAC-CE. The first information includes at least one of the followings: a satellite ephemeris data or a timing advance related parameter. In some examples, the first information is applied for the serving cell. The validity duration is a time interval with a unit of at least one of the followings: an absolute time (e.g., millisecond, or microsecond, or second, etc.) or slot, where the slot length is derived according to a subcarrier spacing or a frame. The serving cell configures the validity duration in a first PDSCH, where the first PDSCH may comprise system information and it is broadcasted to UEs within the serving cell. Alternatively, the first PDSCH may comprise UE-dedicated RRC signaling and transmitted to the UE. When the UE receives the validity duration configuration, the UE can derive a starting time (TO) for the validity time. In some examples, the starting time TO is relevant to the reception of the first PDSCH. For example, TO is relevant to a slot or a frame in which the first PDSCH is received. Optionally, the TO is a boundary of the slot or a boundary of the frame in which the first PDSCH is received.

In some examples, the starting time TO is relevant to the reception of a second PDSCH, where the second PDSCH carries the first information. For example, the TO is relevant to a slot or a frame in which the second PDSCH is received. Optionally, the TO is a boundary of the slot or a boundary of the frame in which the second PDSCH is received. In some examples, the second PDSCH is periodically transmitted by the serving cell. In this case, the TO is relevant to an earliest second PDSCH after the reception of the first PDSCH. Optionally, the earliest second PDSCH should satisfy a processing time, where an interval from the last symbol of the first PDSCH to the first symbol of the second PDSCH is greater than or equal to a second time interval. The second time interval is relevant to UE processing PDSCH time. In some examples, the second time interval is pre-defined. In some examples, the first PDSCH and the second PDSCH may be a same PDSCH.

In some examples, when the second PDSCH is periodically transmitted by the serving cell and the when the UE starts the validity duration from the TO, the UE shall receive at least once the second PDSCH again within the validity time. This ensures that the UE obtains an updated first information. After the UE receives again a second PDSCH, the UE starts a new validity duration from a new TO. In some examples, if the UE autonomously decides which second PDSCH to be received within a validity duration, the network may not have a full control of the validity duration updates. This results in a consequence that after some time the network will completely lose the information about the validity duration on the UE side which will put the network scheduling in danger. To resolve this issue, one solution is to let the UE report to the network once the validity duration is updated. This reporting may be realized by sending an uplink channel, which comprises at least one of the followings: a PRACH, a PUCCH, a PUSCH, or an SRS.

Optionally, the UE may follow a pre-defined rule to receive a new second PDSCH within a validity duration. This way the network knows which second PDSCH the UE will receive and also knows that based on the second PDSCH the validity duration will be updated. One example of the pre-defined rule is that when a UE starts a validity duration and there are multiple periodic second PDSCHs transmitted by the network during the validity duration, the UE receives a last second PDSCH (the one that is the closest to the end of the validity duration). Optionally, the network may configure a monitoring window and the UE will monitor the PDCCH that schedules the first PDSCH and/or the second PDSCH. In some examples, the UE will monitor the PDCCH according to a search space set within the monitoring window, where the search space set may be further pre-configured or pre-defined by the network. In some examples, the search space set is a common search space set. In some examples, the start of the monitoring window is periodic and/or is pre-configured. In some examples, the start of the monitoring window is triggered by the network, where the UE needs to receive a second information from the network before starting the monitoring window. It means that if the second information is not received by the UE, the UE will not start the monitoring window. In some examples, the starting time (TO) of the validity duration is relevant to the starting time of the monitoring window in which the UE monitors the PDCCH.

In some examples, a UE cannot directly receive a system information. For example, when a UE is configured with an active DL BWP, which in frequency domain does not cover an initial DL BWP or the subcarrier spacing (SCS) of the active DL BWP is different from the SCS of the initial DL BWP. Or the UE is not configured by the network with common search space set. In this case, the gNB may transmit the first information to the UE via UE-dedicated RRC message or MAC-CE. In some examples, after the UE receives the first information, the UE restarts the validity duration.

It is to note that in this disclosure, the validity duration may also refer to a validity timer, when UE starts/restarts a validity duration, it also refers to that the UE starts/restarts a validity timer. Similarly, when the validity duration ends it also means that the validity timer is no longer running or it is expired.

In some examples, when the validity timer is not running or expired or UE does not receive another second PDSCH within the validity duration, the UE assumes an uplink synchronization lost. Then the UE will perform a RACH procedure. In case the UE's active UL BWP is configured with RACH occasions, the UE performs RACH procedure in the active UL BWP. In some examples, the UE first switches from the UL active BWP to an UL initial BWP, and the UE performs RACH procedure in the initial UL BWP. Optionally, before performing the RACH procedure, the UE receives the system information to obtain the first information.

In some examples, when the validity timer is not running or expired or UE does not receive another second PDSCH within the validity duration, the UE will declare UL synchronization lost or the UE will declare a radio link failure, or the UE will perform a procedure as if the timeAlignmentTimer is not running as shown in TS38.321, or the UE may switch to an idle state.

In some examples, a UE is provided by the network a third information, where the content of the third information is similar to the first information except that the third information is applied for a non-serving cell. The third information is provided in RRC message. For example, the third information is provided in measurement object IE. In some examples, the network may provide a second validity duration for the third information, where the second validity duration may be of same value of the validity duration applied for the serving cell. In some examples, the UE will perform measurement for the non-serving cell when the validity duration is not expired or when the validity timer is still running.

Commercial interests for some embodiments are as follows. 1. Solving issues in the prior art. 2. Establishing a synchronization in uplink. 3. Providing a method for the UE to track a satellite status information. 4. Providing a good communication performance. 5. Providing a high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method by a user equipment (UE), comprising:
being configured, by a base station or a serving cell of the UE, with a validity duration;
receiving a first information comprising a satellite ephemeris data and/or a timing advance related parameter from the serving cell within the validity duration; and
deriving a starting time for the validity time.

2. The method of claim 1, wherein the first information is received from a system information, a UE-dedicated radio resource control (RRC) signaling, or a media access control-control element (MAC-CE).

3. The method of claim 1, wherein the validity duration is a time interval with a unit of an absolute time and/or a slot, where a length of the slot is derived according to a subcarrier spacing or a frame.

4. The method of claim 1, wherein the first information is carried in a first physical downlink shared channel (PDSCH).

5. The method of claim 4, wherein the starting time of the validity duration is relevant to a reception of the first PDSCH.

6. The method of claim 5, wherein the starting time is relevant to a reception of a second PDSCH, and the first PDSCH and the second PDSCH are same.

7. The method of claim 6, wherein when the second PDSCH is periodically transmitted by the serving cell and when the UE starts the validity duration from the starting time, the UE receives at least once the second PDSCH again within the validity time.

8. The method of claim 7, wherein after the UE receives again the second PDSCH, the UE starts a new validity duration from a new starting time.

9. The method of claim 6, further comprising being configured, by the base station, with a monitoring window and monitoring a physical downlink control channel (PDCCH) that schedules the first PDSCH and/or the second PDSCH.

10. The method of claim 9, wherein a start of the monitoring window is triggered by the base station, where the UE receives second information from the base station before starting the monitoring window, and/or a starting time of the validity duration is relevant to a starting time of the monitoring window in which the UE monitors the PDCCH.

11. The method of claim 1, wherein the validity duration comprises a validity timer.

12. A wireless communication method by a base station, comprising:
configuring or controlling a serving cell of a user equipment (UE) to configure, to the UE, a validity duration;
controlling the UE to receive a first information comprising a satellite ephemeris data and/or a timing advance related parameter from the serving cell within the validity duration; and
controlling the UE to derive a starting time for the validity time.

13. A user equipment (UE), comprising:
a memory;
a transceiver; and
a processor coupled to the memory and the transceiver;
wherein the processor is configured to perform:
being configured, by a base station or a serving cell of the UE, with a validity duration;
receiving a first information comprising a satellite ephemeris data and/or a timing advance related parameter from the serving cell within the validity duration; and
deriving a starting time for the validity time.

14. The UE of claim 13, wherein the first information is received from a system information, a UE-dedicated radio resource control (RRC) signaling, or a media access control-control element (MAC-CE).

15. The UE of claim 13, wherein the validity duration is a time interval with a unit of an absolute time and/or a slot, where a length of the slot is derived according to a subcarrier spacing or a frame.

16. The UE of claim 13, wherein the first information is carried in a first physical downlink shared channel (PDSCH).

17. The UE of claim 16, wherein the starting time of the validity duration is relevant to a reception of the first PDSCH, and the starting time is relevant to a reception of a second PDSCH, and the first PDSCH and the second PDSCH are same.

18. The UE of claim 17, wherein when the second PDSCH is periodically transmitted by the serving cell and when the UE starts the validity duration from the starting time, the UE receives at least once the second PDSCH again within the validity time.

19. The UE of claim 18, wherein after the UE receives again the second PDSCH, the UE starts a new validity duration from a new starting time.

20. The UE of claim 17, wherein the processor is configured to perform: being configured, by the base station, with a monitoring window and monitoring a physical downlink control channel (PDCCH) that schedules the first PDSCH and/or the second PDSCH,
wherein a start of the monitoring window is triggered by the base station, where the UE receives second information from the base station before starting the monitoring window, and/or a starting time of the validity duration is relevant to a starting time of the monitoring window in which the UE monitors the PDCCH, wherein the validity duration comprises a validity timer.
